(19) United States
(12) Patent Application Publication
(10) Pub. No.: US 2022/0283765 A1
(43) Pub. Date: Sep. 8, 2022

(54) IMAGE FORMING APPARATUS

(71) Applicant: KYOCERA Document Solutions Inc., Osaka (JP)

(72) Inventors: Yoshiaki YASUI, Osaka (JP); Masahiro NISHIYAMA, Osaka (JP); Narihiko SUESE, Osaka (JP); Tsuyoshi NITTA, Osaka (JP); Ikuya OHARA, Osaka (JP); Ryota DOI, Osaka (JP); Shunsuke SASAKI, Osaka (JP)

(73) Assignee: KYOCERA Document Solutions Inc., Osaka (JP)

(21) Appl. No.: 17/632,171

(22) PCT Filed: Aug. 4, 2020
(86) PCT No.: PCT/JP2020/029736

§ 371 Date: Feb. 1, 2022

(30) Foreign Application Priority Data
Aug. 8, 2019 (JP) 2019-146532

(51) Int. Cl. G06F 3/12

(52) U.S. Cl. CPC G06F 3/1274; G06F 3/121

(57) ABSTRACT

An image forming apparatus (100) has an operation panel (5), a storage portion (2), an image reading portion (3), and a controller (1). On recognizing a job executed after a job is canceled as a result of a cancellation instruction being accepted to be a retried job, the controller (1), based on job information on the canceled job and job information on the retried job, detects as an error-prone item a setting item for which a set value differs between the canceled job and the retried job, and makes the storage portion (2) store improper setting information including information indicating the error-prone item.

### TECHNICAL FIELD

The present invention relates to an image forming apparatus provided with an image reading portion.

### BACKGROUND ART

Image forming apparatuses that execute jobs involving the reading of a document are known. Such an image forming apparatus can be seen, for example, in Patent Document 1 identified below.

The image forming apparatus disclosed in Patent Document 1 is a multifunction peripheral that can execute a transmission job such as a fax job. When the image forming apparatus disclosed in Patent Document 1 encounters an error in a transmission job, it records history information on the transmission job that induced the error. When executing a new transmission job, based on the history information the image forming apparatus identifies a setting item that can induce an error.

According to Patent Document 1, for example, in a case where an error occurred earlier in which data failed to be transmitted to an addressee (fax number) set by a user, when a new transmission job is executed, if the addressee of the new transmission job is identical with the addressee of the earlier transmission job that induced the error, the user is prompted to re-set the transmission destination (an entry field for the transmission destination is left blank).

### CITATION LIST

### Patent Literature

Patent Document 1: Japanese unexamined patent application publication No. 2013-135414

### SUMMARY OF INVENTION

### Technical Problem

In general an image forming apparatus can accept from a user a cancellation instruction during the execution of a job. On accepting a cancellation instruction, the image forming apparatus cancels the job.

For example, if during the execution of a job a user realizes having made an improper setting for the job, the user enters a cancellation instruction. Thus a cancellation instruction from a user is entered in a state where no error is present.

Here, if the user entered a cancellation instruction earlier (if the user once made an improper setting for a job), to prevent the recurrence of a similar improper setting, it is necessary to have identified the cause for the user having entered the cancellation instruction (the setting item for which the user made the improper setting). If the cause for the user having entered the cancellation instruction can be identified, it is possible to prompt the user to check the set value for a setting item for which the user once made an improper setting. That is, it is possible to prevent the recurrence of an improper setting.

Inconveniently, with the configuration of Patent Document 1, it is possible to identify a setting item that induced an error but it is not possible to identify the cause for a user having entered a cancellation instruction (a setting item for which the user made an improper setting).

The present invention has been devised to solve the inconvenience mentioned above, and is aimed at providing an image forming apparatus that permits easy identification of the cause of a user having entered a cancellation instruction for a job.

### Solution to Problem

To achieve the above object, according to one aspect of the present invention, an image forming apparatus includes: an operation panel which accepts from a user a setting for a job involving the reading of a document and which accepts from the user an execution instruction and a cancellation instruction for the job; a storage portion which stores job information including information indicating a set value for the job; an image reading portion which, when the job is executed, reads the document set and generates the image data of the document read; and a controller which controls the job. When the controller recognizes a job executed after a job is canceled as a result of a cancellation instruction being accepted to be a retried job, the controller performs, based on job information on the canceled job, that is, the job canceled, and job information on the retried job, processing to detect as an error-prone item a setting item for which the set value differs between the canceled job and the retried job. The controller then makes the storage portion store improper setting information including information indicating the error-prone item.

### Advantageous Effects of Invention

With a configuration according to the present invention, it is possible to easily identify the cause for a user having entered a cancellation instruction for a job.

### BRIEF DESCRIPTION OF DRAWINGS

FIG. 1 is a block diagram showing the configuration of an image forming apparatus according to an embodiment of the present invention;

FIG. 2 is an outline diagram showing the configuration of the image forming apparatus according to the embodiment of the present invention;

FIG. 3 is a diagram showing a job setting screen displayed on an operation panel on the image forming apparatus according to the embodiment of the present invention;

FIG. 4 is a flow chart showing a procedure for improper setting information generation processing performed by a controller in the image forming apparatus according to the embodiment of the present invention;

FIG. 5 is a diagram showing transition of screens displayed on the operation panel on the image forming apparatus according to the embodiment of the present invention;

FIG. 6 is a flow chart of a procedure for condition checking processing performed by the controller in the image forming apparatus according to the embodiment of the present invention;

FIG. 7 is a flow chart showing a procedure for setting confirmation processing performed by the controller in the image forming apparatus according to the embodiment of the present invention;

FIG. 8 is a diagram showing a confirmation message displayed on the operation panel on the image forming apparatus according to the embodiment of the present invention.

### DESCRIPTION OF EMBODIMENTS

<Configuration of an Image Forming Apparatus>

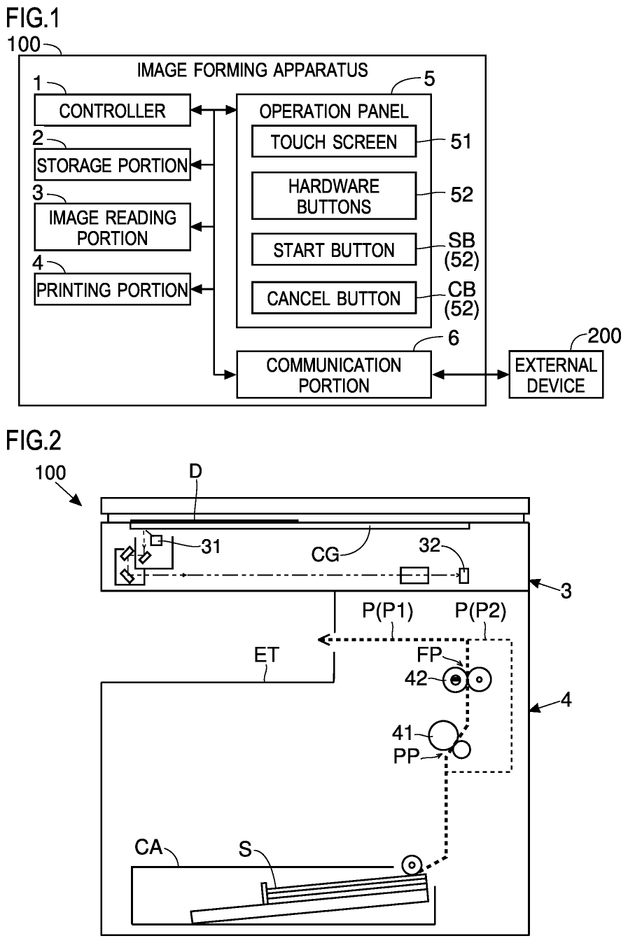

As shown in FIG. 1, an image forming apparatus 100 according to an embodiment includes a controller 1 and a storage portion 2. The controller 1 includes a CPU. The controller 1 controls the image forming apparatus 100 based on control programs and control data. The storage portion 2 includes storage devices such as a ROM, a RAM, and a HDD. The control programs and the control data are stored in the storage portion 2. The storage portion 2 is connected to the controller 1. The controller 1 writes information to and reads information from the storage portion 2.

The image forming apparatus 100 includes an image reading portion 3 and a printing portion 4. The controller 1 controls the reading operation by the image reading portion 3. The controller 1 also controls the printing operation by the printing portion 4. FIG. 2 is an outline diagram of the image reading portion 3 and the printing portion 4.

When a job involving the reading of a document D is executed, the image reading portion 3 reads the document D and generates the image data of the document D. The image reading portion 3 includes a contact glass CG. The document D as a reading target is set on the contact glass CG.

The image reading portion 3 includes an optical system unit that optically reads the document D. The optical system unit includes a light source 31 and an image sensor 32. The light source 31 shines light on the document D set on the contact glass CG. The image sensor 32 receives and performs photoelectric conversion on the light reflected from the document D.

When a copy job (one kind of job involving the reading of a document D) is executed, the printing portion 4 prints an image on a sheet S. Sheets S are stored in a sheet cassette CA. Different kinds of sheets S can be used, examples including regular-paper sheets, thick-paper sheets (such as postcards), and OHP sheets.

When a copy job is executed, the printing portion 4 forms a toner image based on the image data of the document D obtained through the reading of the document D by the image reading portion 3. The printing portion 4 also conveys the sheet S along a sheet conveyance passage P (indicated by broken lines in FIG. 2). The printing portion 4 then transfers the toner image to the sheet S being conveyed.

The sheet conveyance passage P includes a main conveyance passage P1. The main conveyance passage P1 extends from the sheet cassette CA via a printing position PP and a fixing position FP in this order to reach a discharge tray ET. The sheet conveyance passage P further includes a duplex-printing conveyance passage P2. In FIG. 2, the main conveyance passage P1 is indicated by a thick broken line for distinction from the duplex-printing conveyance passage P2.

The duplex-printing conveyance passage P2 branches off the main conveyance passage P1 at a position along it downstream of the fixing position FP in the sheet conveyance direction, and meets the main conveyance passage P1 at a position along it upstream of the printing position PP in the sheet conveyance direction.

The printing portion 4 includes a pair of transfer rollers 41. The pair of transfer rollers 41 is disposed at the printing position PP. The pair of transfer rollers 41 includes a photosensitive drum and a transfer roller. The photosensitive drum carries a toner image on its circumferential surface. The transfer roller is disposed in pressed contact with the photosensitive drum, and forms a transfer nip against it. By rotating, the pair of transfer rollers 41, while conveying the sheet S that has entered the transfer nip, transfers the toner image to the sheet S.

The printing portion 4 includes a pair of fixing rollers 42. The pair of fixing rollers 42 is disposed at the fixing position FP. The pair of fixing rollers 42 includes a heating roller and a pressing roller. The heating roller incorporates a heater. The pressing roller is disposed in pressed contact with the heating roller, and forms a fixing nip against it. By rotating, the pair of fixing rollers 42, while conveying the sheet S that has entered the fixing nip, fixes the toner image to the sheet S.

In simplex printing, when a sheet S having an image formed on one side (here referred to as a one-side-printed sheet) passes across the fixing position FP, the printing portion 4 conveys the one-side-printed sheet S direct along the main conveyance passage P1. The printing portion 4 then discharges the one-side-printed sheet S on the discharge tray ET.

In duplex printing, when a one-side-printed sheet S passes across the fixing position FP, the printing portion 4 switches back the one-side-printed sheet S, and pulls the switched back one-side-printed sheet S into the duplex-printing conveyance passage P2. Then the printing portion 4 conveys the one-side-printed sheet S along the duplex-printing conveyance passage P2 and thereby returns the one-side-printed sheet S to the main conveyance passage P1, to a position along it upstream of the printing position PP in the sheet conveyance direction. The printing portion 4 then conveys the one-side-printed sheet S to the printing position PP. When the one-side-printed sheet S returned to the main conveyance passage P1 passes across the printing position PP, the one-side-printed sheet S now has its sides reversed. Thus, an image is printed on the side of the one-side-printed sheet S on which no image has been printed yet. The sheet S having images printed on both sides is conveyed along the duplex-printing conveyance passage P2 and is discharged on the discharge tray ET.

Referring back to FIG. 1, the image forming apparatus 100 includes an operation panel 5. The operation panel 5 includes a touch screen 51. The touch screen 5 displays various kinds of information, and accepts operation by the user. The operation panel 5 also includes a plurality of hardware buttons 52. The hardware buttons 52 include, for example, a Start button SB and a Cancel button CB. The Start button SB accepts from the user an execution instruction for a job. The Cancel button CB accepts from the user a cancellation instruction for a job.

The operation panel 5 is connected to the controller 1. The controller 1 controls the displaying operation by the operation panel 5. The controller 1 also senses operation performed on the operation panel 5.

The image forming apparatus 100 includes a communication portion 6. The communication portion 6 includes a LAN communication circuit and the like. The communication portion 6 is connected to a wireless LAN access point.

The communication portion 6 is connected to the controller 1. The controller 1 controls the LAN communication circuit in the communication portion 6. Using the communication portion 6 the controller 1 transmits and receives data to and from an external device 200. In a transmission job (another kind of job involving the reading of a document D), the image data of a document D obtained through the reading of the document D by the image reading portion 3 is transmitted to the external device 200.

<Job Involving the Reading of a Document>

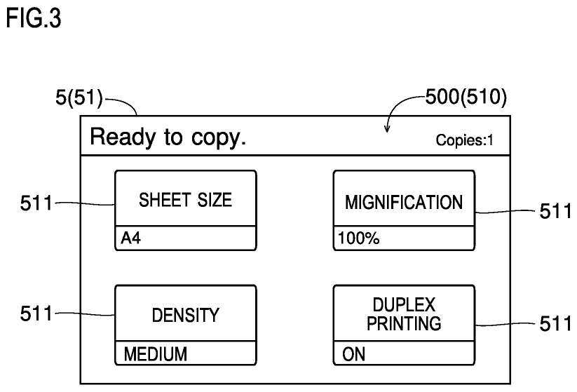

In a job involving the reading of a document D (in the following description referred to simply as a job), the operation panel 5 accepts settings for the job. When accepting settings for a job from a user, the operation panel 5 displays a job setting screen 500 (see FIG. 3).

The job setting screen 500 shown in FIG. 3 is a copy job setting screen 510. When the image forming apparatus 100 starts up, though not illustrated, a home screen is displayed on the operation panel 5. On the home screen, operation for selecting a kind of job is accepted. When a copy job is selected, the operation panel 5 displays the copy job setting screen 510 as the job setting screen 500. When a transmission job is selected, the operation panel 5 displays a transmission job setting screen (not illustrated) as the job setting screen 500.

The job setting screen 500 is a screen that accepts the setting of set values (changing from default values) for a plurality of setting items with respect to a job. The copy job setting screen 500 (510) accepts the setting of set values for setting items “sheet size”, “magnification”, “density”, “duplex printing”, etc. The transmission job setting screen 500 accepts the setting of set value for setting items “transmission destination”, “transmission type”, etc. The setting items specifically mentioned here are merely some examples, and many other setting items for which set values can be set (changed) are available.

The copy job setting screen 500 (510) has a plurality of item buttons 511. The item buttons 511 each correspond to one of a plurality of setting items with respect to a copy job. The display area of each item button 511 is labeled with the name of the corresponding setting item. The display area of each item button 511 shows the current set value for the corresponding setting item.

For example, when the item button 511 for the setting item “duplex printing” is operated, the operation panel 5 displays an item-specific setting screen (not illustrated) that accepts the setting of a set value for simplex printing. For the setting item “duplex printing”, whether duplex printing is on or off corresponds to the set value: setting it on leads to duplex printing being performed, and setting it off leads to simplex printing being performed.

The screen that accepts setting varies from one setting item to another. For example, for some setting items, item-specific setting screens like that for the setting item “duplex printing” are available and, for other setting items, setting values are accepted on the main screen for a job (for a copy job, the copy job setting screen 510 shown in FIG. 3 correspond to the main screen). For example, for a copy job, a set value for the setting item “number of copies” can be set on the main screen (copy job setting screen 510). For a transmission job, a set value for the setting item “transmission destination” can be set on the main screen.

Having made settings for a job, the user enters an execution instruction for the job on the operation panel 5. The operation panel 5 accepts operation on the Start button SB as an execution instruction for a job. On recognizing an execution instruction for a job, the controller 1 starts the job.

When the controller 1 recognizes an execution instruction for a job while the copy job setting screen 500 (510) is displayed, it judges that it has received an instruction to execute a copy job. When the controller 1 recognizes an execution instruction for a job while the transmission job setting screen 500 is displayed, it judges that it has received an instruction to execute a transmission job. On receiving an execution instruction for a job, the controller 1 starts the job. Specifically, the controller 1 makes the image reading portion 3 read a document D.

When the job to be executed is a copy job, the controller 1 refers to the settings that the user has set for the copy job, and makes the printing portion 4 perform printing in accordance with those settings. The printing portion 4 prints on a sheet S an image based on the image data of the document D obtained through the reading of the document D by the image reading portion 3. For example, if the setting item “duplex printing” is set on, the printing portion 4 performs duplex printing.

When the job to be executed is a transmission job, using the operation panel 5 the controller 1 transmits to the external device 200 the image data of the document D obtained through the reading of the document D by the image reading portion 3. The image data is transmitted to the transmission destination set by the user.

<Canceling a Job>

If after the start of a job a user realizes having made an improper setting for the job, the user can enter a cancellation instruction for the job. The operation panel 5 accepts operation on the Cancel button CB as a cancellation instruction for a job. On recognizing a cancellation instruction for a job, the controller 1 cancels the execution of the job that is being executed.

A user may enter a cancellation instruction for a job any time. For example, a cancellation instruction for a job may be entered during the reading of a document D. For another example, a cancellation instruction for a job may be entered after the reading of a document D (during printing or during data transmission).

On recognizing a cancellation instruction for a job, the controller 1 resets the current settings for the job. That is, the set values for a plurality of setting items are all set back to the default values. Then the controller 1 makes the operation panel 5 accept settings for the job.

Generally, if a user enters a cancellation instruction for a job, the user then once again performs the setting of the job to instruct to retry the job. Then the user once again enters an execution instruction for the job.

<Setting Confirmation Function>

The image forming apparatus 100 is provided with a setting confirmation function which permits a user to check whether the user has made an improper setting. Processing (in the following description referred to as setting confirmation processing) involved in the setting confirmation function is performed by the controller 1. The controller 1 performing the setting confirmation processing helps restrain a job from being executed (continued) with an improper setting.

The controller 1 performs the setting confirmation processing based on improper setting information which is information on improper settings made earlier. When a job is canceled and is then retried, the controller 1 performs improper setting information generation processing to generate improper setting information corresponding to the job just canceled, and makes the storage portion 2 store the improper setting information. Improper setting information is stored in the storage portion 2 each time a job is retried. Accordingly a plurality of pieces of improper setting information can be stored in the storage portion 2. Incidentally, to secure a given storage area for improper setting information, a predetermined number of pieces of improper setting information may be deleted at predetermined time intervals starting with those with the oldest dates of generation.

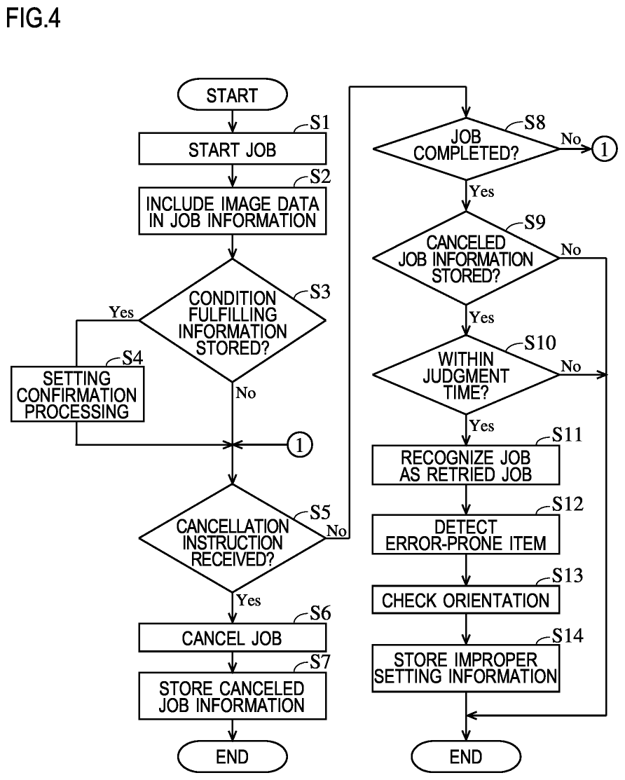

The setting confirmation function will be described below. First, with respect to the flow chart in FIG. 4, the procedure of the improper setting information generation processing performed by the controller 1 will be described.

The procedure shown in FIG. 4 starts when the controller 1 recognizes to have received an execution instruction for a job. It should be noted that, at the time that the procedure shown in FIG. 4 starts, the user has already made settings for a new job to be executed this time. The controller 1 makes the storage portion 2 store job information which is information on the new job. The job information on the new job is stored on a volatile memory device (RAM). The controller 1 includes, in the job information on the new job, information indicating setting values for the new job.

The controller 1 includes, in the job information on the new job, also user information on the user who has instructed to execute the new job. The controller 1 recognizes the user who was logged in when it received an execution instruction for a job as the user who has instructed to execute the job.

In step S1 the controller 1 starts the job. Specifically the controller 1 makes the image reading portion 3 read a document D. The image reading portion 3 reads the document D, and generates the image data of the document D read. When starting the job the controller 1 recognizes the start time of the job and includes, in the job information on the new job, information indicating the start time recognized (makes the storage portion 2 store the start time of the job). The start time of a job is the time at which the user entered the execution instruction for it.

If the new job is a copy job, then after the image reading portion 3 starts to read the document D, the controller 1 makes the printing portion 4 to perform printing. The printing portion 4 prints on a sheet S an image based on the image data of the document D obtained through the reading of the document D by the image reading portion 3. If the number of pages to be handled in the new job (the number of sheets in the document D to be read) is more than one, then after the image reading portion 3 has read all of the plurality of sheets in the document D (has generated the image data of the plurality of pages), the controller 1 makes the printing portion 4 perform printing.

If the new job is a transmission job, then after the image reading portion 3 starts to read the document D, the controller 1, using the communication portion 6, transmits the image data of the document D obtained through the reading of the document D by the image reading portion 3 to an external device 200. For example, transmission data (e.g., PDF data) based on the image data of the document D is transmitted to the external device 200. If the number of pages to be handled in the new job (the number of sheets in the document D to be read) is more than one, then after the image reading portion 3 has read all of the plurality of sheets in the document D (has generated the image data of the plurality of pages), the controller 1 generates transmission data in which the image data of the plurality of pages is consolidated together and transmits it to the external device 200.

In step S2 the controller 1 acquires the image data of a predetermined page out of the image data obtained by execution of the new job. For example, the image data of the first page is acquired (the predetermined page can be the first page). If the number of pages handled in the new job is more than one, the image data of any of the second and following pages may be acquired (e.g., the image data of the last page may be acquired). The controller 1 then includes, in the job information on the new job, the image data of the predetermined page acquired.

In step S3 the controller 1 performs condition checking processing to check whether improper setting information that fulfills a predetermined condition (hereinafter referred to as condition fulfilling information) is stored in the storage portion 2. The condition checking processing will be described in detail later.

If in step S3 the controller 1 finds that condition fulfilling information is stored in the storage portion 2, the procedure proceeds to step S4. In step S4 the controller 1 performs setting confirmation processing. The setting confirmation processing will be described in detail later.

If in step S3 the controller 1 finds that no condition fulfilling information is stored in the storage portion 2, the procedure proceeds to step S5. If in step S3 the controller 1 finds that condition fulfilling information is stored in the storage portion 2, the procedure proceeds from step S3 via step S4 to step S5.

In step S5 the controller 1 checks whether it has received a cancellation instruction for the job. For example if a user having entered an execution instruction for a job later realizes having made an improper setting, the user enters a cancellation instruction for the job.

If in step S5 the controller 1 recognizes to have received a cancellation instruction for the job, the procedure proceeds to step S6. In step S6 the controller 1 cancels the job.

In step S7 the controller 1 moves the job information on the new job (the job canceled) from the current storage area to another area (a predetermined area for storage of job information on a canceled job) to make the storage portion 2 store it as canceled job information. In the following description, a job canceled is called a canceled job.

When a job is canceled, the controller 1 recognizes the cancellation time of the canceled job, and includes, in the canceled job information on the canceled job, information indicating the cancellation time recognized (makes the storage portion 2 store the cancellation time of the canceled job). The cancellation time of a canceled job is the time that the user entered a cancellation instruction for it.

For example, when making the storage portion 2 (the predetermined area for storage of canceled job information) store canceled job information, if other canceled job information already exists, the controller 1 erases the existing canceled job information from the storage portion 2 (predetermined area). That is, the storage portion 2 (predetermined area) stores a single piece of canceled job information.

If in step S5 the controller 1 recognizes not to have received a cancellation instruction for the job, the procedure proceeds to step S8. In step S8 the controller 1 checks whether the job has been completed normally. If the controller 1 judges that the job has not been completed, the procedure proceeds to step S5. On the other hand, if the controller 1 judges that the job has been completed normally, the procedure proceeds to step S9.

In step S9 the controller 1 checks whether canceled job information is stored in the storage portion 2 (the predetermined area for storage of canceled job information). If the controller 1 finds that canceled job information is stored in the storage portion 2 (predetermined area), the procedure proceeds to step S10.

In step S10 the controller 1 refers to the start time included in the job information on the new job (normally completed job). The controller 1 also refers to the cancellation time included in the canceled job information on the canceled job. Then the controller 1 checks whether the time from the cancellation time of the canceled job to the start time of the new job falls within a prescribed judgment time. In other words, the controller 1 checks whether the new job is a retried job (i.e., a job canceled and now tried to be executed anew).

Here, if a user has entered a cancellation instruction for a job because of having made an improper setting, the user promptly performs the re-setting of the job. The user then enters an execution instruction for the job. That is, if the cancellation of a job results from an improper setting, an execution instruction for the job is entered within a comparatively short time (e.g., within about one minute or less) of the entry of the cancellation instruction for the job. Thus the time from the cancellation time of the canceled job to the start time of the new job seldom exceeds a few minutes (two to three minutes). Accordingly the judgment time for the judgment of whether a new job is a retried job is set at, for example, one minute.

The judgment time can be set (changed) as desired by the user. The setting of the judgment time is accepted on the operation panel 5. For example, in a case where the user is not accustomed to the operation of the image forming apparatus 100, the time from the cancellation time to the start time tends to be longer. In that case, the judgment time can be set at two to three minutes.

If in step S10 the controller 1 judges that the time from the cancellation time of the canceled job to the start time of the new job falls within the judgment time, the procedure proceeds to step S11. In step S11 the controller 1 judges that the new job is a retried job. That is, the controller 1 recognizes a job executed within a predetermined time of the cancellation time of a canceled job to be a retried job.

If in step S9 the controller 1 finds that no canceled job information is stored in the storage portion 2, the procedure ends. Likewise also if in step S10 the controller 1 judges that the time from the cancellation time of the canceled job to the start time of the new job does not fall within the judgment time, the procedure ends. In these cases, the controller 1 recognizes the new job not to be a retried job.

In step S12 the controller 1 performs detection processing to detect an error-prone item. An error-prone item is a setting item for which a user is likely to have made an improper setting when setting a canceled job.

In the detection processing, the controller 1 compares the set values for the setting items included in the canceled job information on a canceled job with the set values for the setting items included in the job information on a retried job (a new, normally completed job). In so doing the controller 1 detects as an error-prone item a setting item for which the set value differs between the canceled job and the retried job. As the case may be, a plurality of setting items can be detected as error-prone items.

For example, in a case where, for duplex printing, one-side waste sheets (sheets S blank only on one side) are set in the sheet cassette CA, on seeing a printed result, the user immediately enters a cancellation instruction for the job, re-sets the set value for the setting item “duplex printing” to off, and enters an execution instruction for the job. In this example, whereas for the canceled job the set value for the setting item “duplex printing” was on, for the retried job the set value for the setting item “duplex printing” is off. That is, the set value for the setting item “duplex printing” differs between the canceled job and the retried job. Thus the setting item “duplex printing” is detected as an error-prone item.

On the other hand, consider a case where for a canceled job the set value for the setting item “sheet size” is set to A4 and also for a retried job the set value for the setting item “sheet size” is set to A4. In this case, the set value for the setting item “sheet size” is the same for the canceled job and the retried job. Thus the setting item “sheet size” is not detected as an error-prone item.

In step S13 the controller 1 performs orientation checking processing. The controller 1 checks whether the orientation of the image data obtained by execution of a canceled job is improper (whether the orientation of the image data obtained by execution of the canceled job differs from that obtained by execution of the retried job). In other words, the controller 1 checks whether the orientation of the document D set on the contact glass CG during the execution of the canceled job was improper.

For example, in the orientation checking processing, the controller 1 turns the image data of the canceled job in 90-degree increments to check whether the image data turned through 90 degrees, 180 degrees, and 270 degrees coincides with the image data of the retried job. If the image data of the canceled job turned through any of the angles coincides with the image data of the retried job, the controller 1 judges that the orientation of the document D in the canceled job was improper (the orientation of the document D set on the contact glass CG during the execution of the canceled job was improper). That is, if the image data of the canceled job without being turned coincides with the image data of the retried job, the controller 1 judges that the orientation of the document D in the canceled job was proper (the orientation of the document D set on the contact glass CG during the execution of the canceled job was proper).

In step S14 the controller 1 generates improper setting information and makes the storage portion 2 store the improper setting information. Improper setting information is stored in a non-volatile storage device (ROM or HDD).

The controller 1 includes, in the improper setting information, information on the error-prone item detected in the processing in step S12. If a plurality of error-prone items have been detected, information on the plurality of error-prone items is included in improper setting information. If in the processing in step S13 the controller 1 judges that the orientation of the image data of the canceled job was improper, the controller 1 includes, in the improper setting information, orientation inconsistency information.

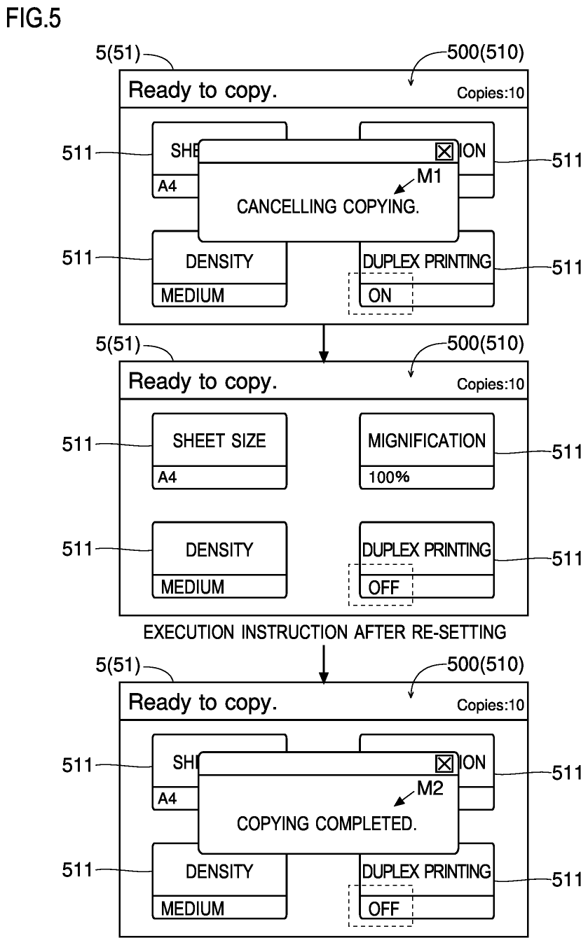

For example, consider a case where a user in the middle of executing a copy job (here referred to as the first copy job) enters a cancellation instruction. In this case, as shown in the upper diagram in FIG. 5, a message M1 indicating that the first copy job is about to be canceled is displayed in a pop-up window on the setting screen 510. Here, assume that the user has entered the cancellation instruction because of having noticed the first copy job being duplex printing (to change the set value for the setting item “duplex printing”). In FIG. 5 the set value for the setting item “duplex printing” is enclosed by a broken line.

The message M1 ceases to be displayed when, for example, the user touches the touch screen 5. When the message M1 ceases to be displayed, the user can perform setting on the setting screen 510. Now the user changes the set value for the setting item “duplex printing” from on to off (see the middle diagram in FIG. 5). The user then once again enters an execution instruction for the job. When the copy job (here referred to as the second copy job) executed by being triggered by the execution instruction is completed normally, then as shown in the lower diagram in FIG. 5 a message M2 indicating that the second copy job has been completed is displayed in a pop-up window on the setting screen 510.

Here, if the time from the cancellation time of the first copy job to the start time of the second copy job falls within the judgment time, the second copy job is recognized as a retried job. In this case, improper setting information on the first copy job is generated. The improper setting information on the first copy job includes information indicating the setting item “duplex printing”. That is, in this example, the error-prone item is the setting item “duplex printing”.

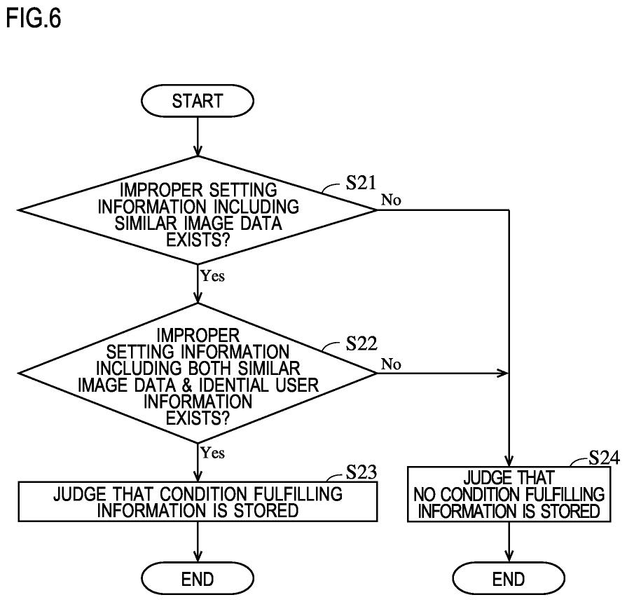

Next, with reference to the flow chart shown in FIG. 6, a procedure of the condition checking processing (the processing in step S3) performed by the controller 1 will be described.

The procedure shown in FIG. 6 starts when the controller 1 acquires the image data of a predetermined page (the first page) of a new job.

In step S21 the controller 1 checks whether there exists improper setting information that includes image data of which the degree of similarity to the image data obtained by execution of a new job is equal to or higher than a prescribed threshold value. A degree of similarity is a value that represents the degree to which something is similar to another thing. The degree of similarity can be determined by a known method.

For example, the controller 1 determines the degree of similarity by arithmetically calculating the degree of overlap between an image within the image data obtained by execution of the new job and an image within the image data included in improper setting information. For another example, the controller 1 extracts feature components from each of an image within the image data obtained by execution of the new job and an image within the image data included in improper setting information. Here the extracted feature components are, for example, the contour of an image, the shape of an image, and the thickness of the line that defines an image. The controller 1 then determines the degree of similarity based on the extracted feature components.

If in step S21 the controller 1 finds that there exists improper setting information that includes similar image data, the procedure proceeds to step S22. In step S22 the controller 1 refers to the user information on the user who has instructed to execute the new job (the user information included in the job information on the new job). The controller 1 moreover searches for improper setting information that includes user information (hereinafter referred to as identical user information) on the same user as the one who has instructed to execute the new job. The controller 1 then checks whether there exits improper setting information that includes both similar image data and identical user information.

If in step S22 the controller 1 finds that there exits improper setting information that includes both similar image data and identical user information, the procedure proceeds to step S23. In step S23 the controller 1 recognizes the improper setting information that includes both similar image data and identical user information as condition fulfilling information (improper setting information that fulfills a predetermined condition). That is, the controller 1 judges that condition fulfilling information is stored in the storage portion 2.

If in step S22 the controller 1 finds that there exits no improper setting information that includes both similar image data and identical user information, the procedure proceeds to step S24. In step S24 the controller 1 judges that no condition fulfilling information is stored in the storage portion 2.

As a modified example, the processing in step 22 may be omitted. In that case, regardless of the user information included in improper setting information, if improper setting information includes similar image data, the controller 1 recognizes the improper setting information including similar image data as condition fulfilling information (judges that condition fulfilling information is stored in the storage portion 2).

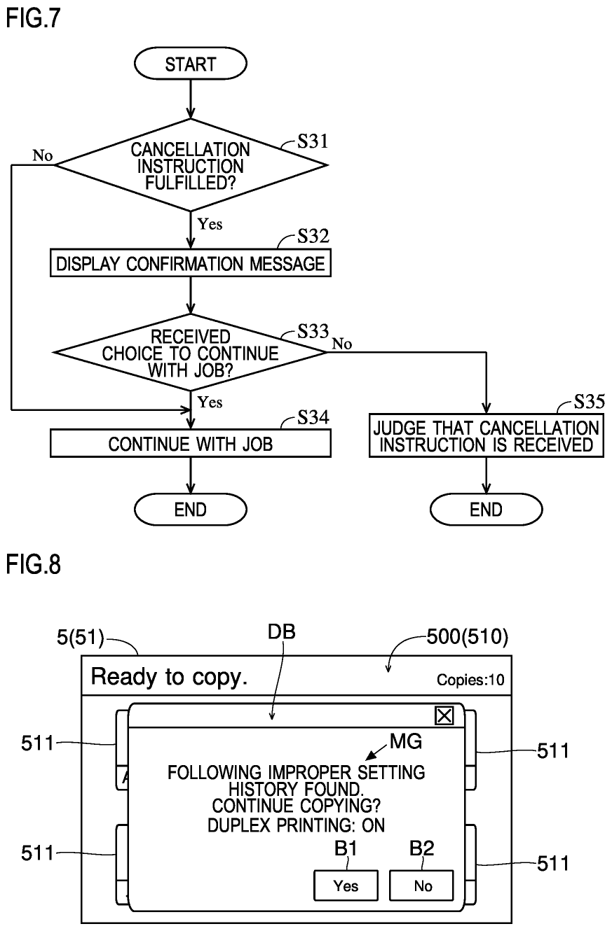

Next, with reference to the flow chart shown in FIG. 7, the setting confirmation processing (the processing in step S4) performed by the controller 1 will be described.

The procedure shown in FIG. 7 starts when the controller 1 judges that condition fulfilling information is stored in the storage portion 2. For example, on judging that condition fulfilling information is stored in the storage portion 2, the controller 1 suspends the job before printing or before data transmission.

In step S31 the controller 1 checks whether a confirmation condition that is prescribed as a condition for displaying a confirmation message MG (see FIG. 8), which will be described later, is fulfilled. For a copy job, for example, three conditions, namely a first, a second, and a third condition, are defined as confirmation conditions. Also for a transmission job, confirmation conditions for a transmission job are defined. Now the first to third conditions defined as confirmation conditions for a copy job will be described.

(1) First Condition

The controller 1 checks the number of pages to be printed in the new job. If the number of pages to be printed in the new job is greater than a prescribed threshold number of pages, the controller 1 judges that the first condition is fulfilled. That is, when the number of pages to be printed is greater, the controller 1 judges that the first condition is fulfilled. The threshold number of pages is, for example, several tens of pages. The threshold number of pages can be changed as desired by the user. The changing of the threshold number of pages is accepted on the operation panel 5.

(2) Second Condition

The controller 1 checks the number of copies to be printed in the new job. If the number of copies to be printed in the new job is greater than a prescribed threshold number of copies, the controller 1 judges that the second condition is fulfilled. That is, when the number of copies to be printed is greater, the controller 1 judges that the second condition is fulfilled. The threshold number of copies is, for example, several tens of copies. The threshold number of copies can be changed as desired by the user. The changing of the threshold number of copies is accepted on the operation panel 5.

(3) Third Condition

The controller 1 checks the type of sheets S to be used (sheets S on which to print images) in the new job. The controller 1 then checks whether the type of sheets S is a predetermined type. If the type of sheets S to be used in the new job is the predetermined type, the controller 1 judges that the third condition is fulfilled. Special sheets such as OHP sheets or postcards are dealt with as special sheets. That is, when the sheets S to be used in the new job is special sheets, it is judged that the third condition is fulfilled. The predetermined type can be changed as desired by the user. The changing of the predetermined type is accepted on the operation panel 5.

If, out of the first, second, and third conditions, one previously selected by the user is fulfilled, the controller 1 judges that the confirmation condition is fulfilled. For example, when the first to third conditions are all selected, if the first to third conditions are all fulfilled, it is judged that the confirmation condition is fulfilled. That is, even if, out of the first to third conditions, one condition is fulfilled, if the other conditions are not fulfilled, it is judged that the confirmation condition is not fulfilled.

When one of the first to third conditions is selected, if that one condition is fulfilled, it is judged that the confirmation condition is fulfilled. When two of the first to third conditions are selected, if those two conditions are fulfilled, it is judged that the confirmation condition is fulfilled.

If in step S31 the controller 1 judges that the confirmation condition is fulfilled, the procedure proceeds to step S32. In step S32 the controller 1 makes the operation panel 5 display a confirmation message MG as shown in FIG. 8. The operation panel 5 displays, for example, a dialog box DB showing the confirmation message MG in a pop-up window on the job setting screen 500.

Here the controller 1 uses as the confirmation message MG a message that prompts the user to check the current set value for an error-prone item included in the condition fulfilling information. FIG. 8 shows the confirmation message MG that is displayed when the setting item “duplex printing” is included as an error-prone item in the condition fulfilling information. The confirmation message MG shown in FIG. 8 is displayed when the user made an improper setting for the setting item “duplex printing” earlier (see FIG. 5).

Here, when making the operation panel 5 display the confirmation message MG, the controller 1 checks whether the condition fulfilling information includes orientation inconsistency information. If the condition fulfilling information includes orientation inconsistency information, the controller 1 includes, in the confirmation message MG, also a message that prompts the user to check whether the document D set on the contact glass CG is set in a proper state (in a proper orientation).

Moreover, while the confirmation message MG is displayed, the controller 1 allows the user to make a choice of whether to continue with (restart) the job that is currently being suspended. For example, the dialog box DB shows a first button B1 labeled “Yes” and a second button B2 labeled “No”. The first button B1 is a software button for accepting a choice to continue with the job unchanged (not to change the settings for the job). The second button B2 is a software button for accepting a choice not to continue with the job (to change settings for the job).

Referring back to FIG. 7, in step S33 the controller 1 checks whether it has accepted a choice to continue with the job unchanged (whether the first button B1 has been operated). If the controller 1 judges that it has received a choice to continue with the job unchanged (that the first button B1 has been operated), the procedure proceeds to step S34. In step S34 the controller 1 continues with the job without changing the settings for the job. Then the procedure proceeds to step S5.

If in step S31 the controller 1 judges that the confirmation condition is not fulfilled, the procedure proceeds from step S31, without going through steps S32 and 33, to step S34. That is, in this case, without the confirmation message MG being displayed, the job is continued.

If in step S33 the controller 1 judges that it has received a choice not to continue with the job (that the second button B2 has been operated), the procedure proceeds to step S35. In step S35 the controller 1 recognizes to have received a cancellation instruction for the job. In this case, the procedure proceeds from step S5 to step S6 in FIG. 4.

With a configuration according to the embodiment, as described above, if the controller 1 recognizes a job executed after a job is canceled as a result of a cancellation instruction being accepted to be a retried job, then based on the job information on the canceled job and the job information on the retried job, the controller 1 performs processing to detect as an error-prone item a setting item for which the set value differs between the canceled job and the retried job, and makes the storage portion 2 store improper setting information including information indicating the error-prone item.

Here the user, after cancelling the job, re-sets the job. At this time the set value for the setting item for which the user made an improper setting is changed. After re-setting the job the user enters an execution instruction for the job. The job that was cancelled with a cancellation instruction is the canceled job, and the job that is executed by the execution instruction after the re-setting is the retried job. Thus comparing the setting information on the canceled job with the setting information on the retried job reveals a difference between the canceled job and the retried job in the set value for the setting item that the user has re-set (the setting item for which the user made an improper setting). Accordingly, by detecting a setting item (error-prone item) for which the set value differs between a canceled job and a retried job, it is possible to identify a setting item for which a user made an improper setting. It is thus possible to easily identify the cause for the user having entered a cancellation instruction for a job (which of a plurality of setting items with respect to the job the user made an improper setting for).

The controller 1 recognizes a job executed within a prescribed judgment time of the cancellation time of a canceled job to be a retried job. This helps restrain a job unrelated to the canceled job from being recognized to be a retried job.

According to the embodiment, as described above, on accepting an execution instruction for a new job, the controller 1 checks whether condition fulfilling information, which is improper setting information that fulfills a predetermined condition, is stored. If condition fulfilling information is stored, the controller 1 makes the operation panel 5 display a confirmation message MG that prompts the user to check the current set value for an error-prone item included in the condition fulfilling information. The confirmation message MG thus displayed leads the user to check the current set value for a setting item (error-prone item) for which the user made an improper setting earlier. This helps prevent a job from being continued with an improper setting.

For example, if the job executed is a copy job, a sheet S with an image printed on it is output. If a setting is improper, the printed sheet S would be wasted.

Conveniently, according to the embodiment, a copy job is prevented from being continued with an improper setting. It is thus possible to save sheets S from being wasted.

According to the embodiment, as described above, if condition fulfilling information includes orientation inconsistency information, the controller 1 includes in the confirmation message MG a message that prompts the user to check how a document D is set. Thus, if the orientation of the document D set on the contact glass CG is improper, the user corrects the orientation of the document D. It is thus possible to prevent a job from being continued with the document D in an improper orientation.

According to the embodiment, as described above, the controller 1 recognizes as condition fulfilling information such improper setting information that includes image data of which the degree of similarity to the image data obtained by execution of a new job is equal to or higher than a prescribed threshold value. It is thus possible to prevent improper setting information on a job of which the reading target is a document D unrelated to the document D read in the new job from being recognized as condition fulfilling information.

Here, even if the reading target is the same document D, the settings for a job vary among users. For example, while one user chooses to copy the document D on a sheet S of A4 size, another user may choose to copy the same document D on a reduced scale on a sheet S of B5 size.

Thus, according to the embodiment, as described above, the controller 1 recognizes as condition fulfilling information such improper setting information that includes image data of which the degree of similarity to the image data obtained by execution of a new job is equal to or higher than a prescribed threshold value and that in addition includes user information on the user who has instructed to execute the new job. It is thus possible to prevent display of a confirmation message MG that prompts the user to check the set value for a setting item for which the user has never made an improper setting.

Here some users may feel frequent display of the confirmation message MG a nuisance. Even so, displaying no confirmation message MG may lead to frequent occurrence of improper settings. For example, continuing a copy job with an improper setting ends up in wasting sheets S.

To prevent that, according to the embodiment, as described above, only if, out of a first to a third condition, one or more are fulfilled, the confirmation message MG is displayed on the operation panel 5. This prevents frequent display of the confirmation message MG. With the first or second condition defined as a confirmation condition, it is possible to prevent a large quantity of sheets S from being wasted. On the other hand, with the third condition defined as a confirmation condition, it is possible to prevent expensive sheets S (special sheets) from being wasted.

The embodiment disclosed herein should be understood to be in every aspect illustrative and not restrictive. The scope of the present disclosure is defined not by the description of the embodiment given above but by the appended claims, and encompasses any modifications within the scope and sense equivalent to the appended claims.

1. An image forming apparatus, comprising:
an operation panel
which accepts from a user a setting for a job involving reading of a document and
which accepts from the user an execution instruction and a cancellation instruction for the job;
a storage portion which stores job information including information indicating a set value for the job;
an image reading portion which, when the job is executed, reads the document set and generates image data of the document read; and
a controller which controls the job,
wherein
when the controller recognizes the job executed after the job is canceled as a result of the cancellation instruction being accepted to be a retried job,
the controller performs, based on job information on a canceled job, which is the job canceled, and job information on the retried job, processing to detect as an error-prone item a setting item for which a set value differs between the canceled job and the retried job, and
the controller makes the storage portion store improper setting information including information indicating the error-prone item.

2. The image forming apparatus according to claim 1, wherein
the controller makes the storage portion store a cancellation time of the canceled job and
the controller recognizes a job executed within a prescribed judgment time of the cancellation time to be a retried job.

3. The image forming apparatus according to claim 1, wherein
when the controller accepts the execution instruction for the job anew, the controller checks whether condition fulfilling information, which is the improper setting information fulfilling a predetermined condition, is stored and,
if the condition fulfilling information is stored, the controller makes the operation panel display a confirmation message prompting the user to check a current set value for the error-prone item included in the condition fulfilling information.

4. The image forming apparatus according to claim 3, wherein
if an orientation of image data obtained by execution of the canceled job and an orientation of image data obtained by execution of the retried job differ, the controller includes orientation inconsistency information in the improper setting information, and
if the condition fulfilling information includes the orientation inconsistency information, the controller includes in the confirmation message a message prompting the user to check how the document is set.

5. The image forming apparatus according to claim 3, wherein
the controller includes image data obtained by execution of the canceled job in the improper setting information, and
the controller recognizes as the condition fulfilling information the improper setting information that includes image data of which a degree of similarity to image data obtained by execution of the job anew is equal to or higher than a prescribed threshold value.

6. The image forming apparatus according to claim 3, wherein
the controller includes image data obtained by execution of the canceled job in the improper setting information,
the controller includes user information on the user who has instructed to execute the canceled job in the improper setting information, and
the controller recognizes as the condition fulfilling information the improper setting information that includes image data of which the degree of similarity to image data obtained by execution of the job anew is equal to or higher than a prescribed threshold value and that in addition includes user information on a user who has instructed to execute the job anew.

7. The image forming apparatus according to claim 3, further comprising a printing portion which, when the job is executed, prints on a sheet an image based on the image data of the document read, wherein
the controller makes the operation panel display the confirmation message only if one or more of the following conditions are fulfilled:
a condition that a number of pages to be printed in the job executed anew is greater than a prescribed threshold number of pages;
a condition that a number of copies to be printed in the job executed anew is greater than a prescribed threshold number of copies; and
a condition that a type of the sheet on which to print the image in the job executed anew is a predetermined type.
